(19) United States
(12) Patent Application Publication
(10) Pub. No.: US 2024/0136834 A1
(43) Pub. Date: Apr. 25, 2024

(54) ELECTRONIC DEVICE AND AN OPERATING METHOD OF THE ELECTRONIC DEVICE

(71) Applicant: SAMSUNG ELECTRONICS CO., LTD., SUWON-SI (KR)

(72) Inventors: JUNHAN BAE, Suwon-si (KR); DONGJOON KIM, Suwon-si (KR); DUSEUNG OH, Suwon-si (KR); WOONHYUNG HEO, Suwon-si (KR)

(21) Appl. No.: 18/202,425

(22) Filed: May 25, 2023

(30) Foreign Application Priority Data
Oct. 20, 2022 (KR) 10-2022-0136875

(51) Int. Cl. H02J 7/00; H02H 7/18

(52) U.S. Cl. CPC H02J 7/00308; H02H 7/18; H02J 7/0042

(57) ABSTRACT

An electronic device including: a connector including a voltage terminal; a battery; a corruption detection circuit configured to detect whether the connector is corrupted; a voltage cutoff circuit configured to electrically connect the voltage terminal with an internal node when corruption of the connector is not detected by the corruption detection circuit and to electrically disconnect the voltage terminal from the internal node when the corruption is detected by the corruption detection circuit; a charging pin connected with the internal node, and configured to transfer a voltage of the internal node to an external device when the charging pin is connected with the external device; and a power management integrated circuit connected between the internal node and the battery, and configured to charge the battery by using the voltage of the internal node or to generate the voltage of the internal node by using a voltage of the battery.

### CROSS-REFERENCE TO RELATED APPLICATION

This application claims priority under 35 U.S.C. § 119 to Korean Patent Application No. 10-2022-0136875 filed on Oct. 21, 2022, in the Korean Intellectual Property Office, the disclosure of which is incorporated by reference herein in its entirety.

### TECHNICAL FIELD

Embodiments of the present disclosure described herein relate to an electronic device, and more particularly, to an electronic device for receiving a voltage from an external first device and transferring a voltage to an external second device and an operating method of the electronic device.

### DISCUSSION OF RELATED ART

A true wireless stereo (TWS) cradle functions as a station for wireless earphones. The TWS cradle may be supplied with a voltage from a first external device and may charge an internal battery. The TWS cradle may charge a second external device by transferring the voltage from the first external device or the charged voltage of the battery to the second external device.

The TWS cradle may be equipped with a connector that is connected to the first external device. However, the connector may become contaminated by conductive contaminants such as water and sweat. The connector of the TWS cradle typically uses a receptacle, which has a structural characteristic that makes it challenging to detect and remove the contaminants.

If the connector of the TWS cradle is contaminated and voltage is supplied from the first external device, the voltage may be transferred through the contaminants, thereby leading to corrosion of both the connector of the TWS cradle and a connector of the first external device connected to the connector of the TWS cradle.

### SUMMARY

Embodiments of the present disclosure provide an electronic device that can charge a second external device irrespective of whether a connector of the electronic device is contaminated or not. This is achieved by detecting corruption in the connector and blocking the electrical connection such that a voltage is not supplied from a first external device. Additionally, embodiments of the present disclosure provide an operating method of the electronic device.

According to an embodiment of the present disclosure, there is provided an electronic device including: a connector including a voltage terminal, a detection terminal, and a data terminal; a battery; a corruption detection circuit configured to detect whether the connector is corrupted; a voltage cutoff circuit connected with the voltage terminal of the connector, and configured to electrically connect the voltage terminal with an internal node when corruption of the connector is not detected by the corruption detection circuit and to electrically disconnect the voltage terminal from the internal node when the corruption is detected by the corruption detection circuit; a charging pin connected with the internal node, and configured to transfer a voltage of the internal node to an external device when the charging pin is connected with the external device, irrespective of whether the corruption is detected; and a power management integrated circuit connected between the internal node and the battery, and configured to charge the battery by using the voltage of the internal node or to generate the voltage of the internal node by using a voltage of the battery.

According to an embodiment of the present disclosure, there is provided an electronic device including: a connector including a voltage terminal, a detection terminal, and a data terminal; a battery; a corruption detection circuit configured to detect whether the connector is corrupted, using different techniques, according to whether an external voltage is supplied through the voltage terminal; a voltage cutoff circuit connected with the voltage terminal of the connector, and configured to electrically connect the voltage terminal with an internal node when corruption of the connector is not detected by the corruption detection circuit and to electrically disconnect the voltage terminal from the internal node when the corruption is detected by the corruption detection circuit; a power management integrated circuit configured to charge the battery by using a voltage of the internal node or to generate the voltage of the internal node by using a voltage of the battery; and a charging pin configured to transfer the voltage of the internal node to an external device when the charging pin is connected with the external device, wherein, when the external voltage is supplied through the voltage terminal and the corruption is not detected by the corruption detection circuit, the charging pin is configured to transfer the external voltage to the external device, and the power management integrated circuit is configured to step down the external voltage to be transferred to the battery, and wherein, when the external voltage is supplied to the voltage terminal and the corruption is detected by the corruption detection circuit, the power management integrated circuit is configured to transfer a voltage of the battery to the charging pin, and the charging pin is configured to transfer the voltage from the power management integrated circuit to the external device.

According to an embodiment of the present disclosure, there is provided an operating method of an electronic device which is configured to be connected with a first external device through a connector and is configured to be connected with a second external device through a charging pin, the method including: detecting whether the connector is corrupted; blocking an electrical connection with a voltage terminal of the connector when the connector is corrupted; establishing the electrical connection with the voltage terminal of the connector when the connector is not corrupted; and providing a voltage to the second external device when the second external device is connected with the charging pin, irrespective of whether the connector is corrupted.

### BRIEF DESCRIPTION OF THE FIGURES

The above and other features of the present disclosure will become apparent by describing in detail embodiments thereof with reference to the accompanying drawings.

FIG. 1 is a diagram illustrating an electronic device according to an embodiment of the present disclosure.

FIG. 2 is a diagram illustrating an example of a connector according to an embodiment of the present disclosure.

FIG. 3 is a diagram illustrating an example of an operating method of an electronic device according to an embodiment of the present disclosure.

FIG. 4 is a diagram illustrating an example of a connector and a corruption detection circuit according to an embodiment of the present disclosure.

FIG. 5 is a diagram illustrating an example in which an electronic device performs corruption detection in different manners according to an embodiment of the present disclosure.

FIG. 6 is a diagram illustrating an example in which a corruption detection circuit performs corruption detection in a pull-up manner according to an embodiment of the present disclosure.

FIG. 7 is a diagram illustrating a process in which corruption detection of a pull-up manner is performed in a connector and a corruption detection circuit according to a method of FIG. 6.

FIG. 8 is a diagram illustrating an example in which after a connector is corrupted, an electronic device detects whether the corruption is removed in a pull-up manner according to an embodiment of the present disclosure.

FIG. 9 is a diagram illustrating an example in which an electronic device performs corruption detection in a pull-down manner according to an embodiment of the present disclosure.

FIG. 10 is a diagram illustrating a process in which corruption detection of a pull-down manner is performed in a connector and a corruption detection circuit according to a method of FIG. 9.

FIG. 11 is a diagram illustrating an example in which after a connector is corrupted, an electronic device detects whether the corruption is removed in a pull-down manner according to an embodiment of the present disclosure.

FIG. 12 is a diagram illustrating an example in which an electronic device operates when an external voltage exists and a connector is not corrupted.

FIG. 13 is a diagram illustrating an example in which an electronic device operates when a connector is corrupted.

### DETAILED DESCRIPTION OF THE EMBODIMENTS

Below, embodiments of the present disclosure will be described in detail and clearly to such an extent that one of ordinary skill in the art can easily implement the present disclosure. Below, the term “and/or” is interpreted as including any one of items listed with regard to the term, or a combination of some of the listed items.

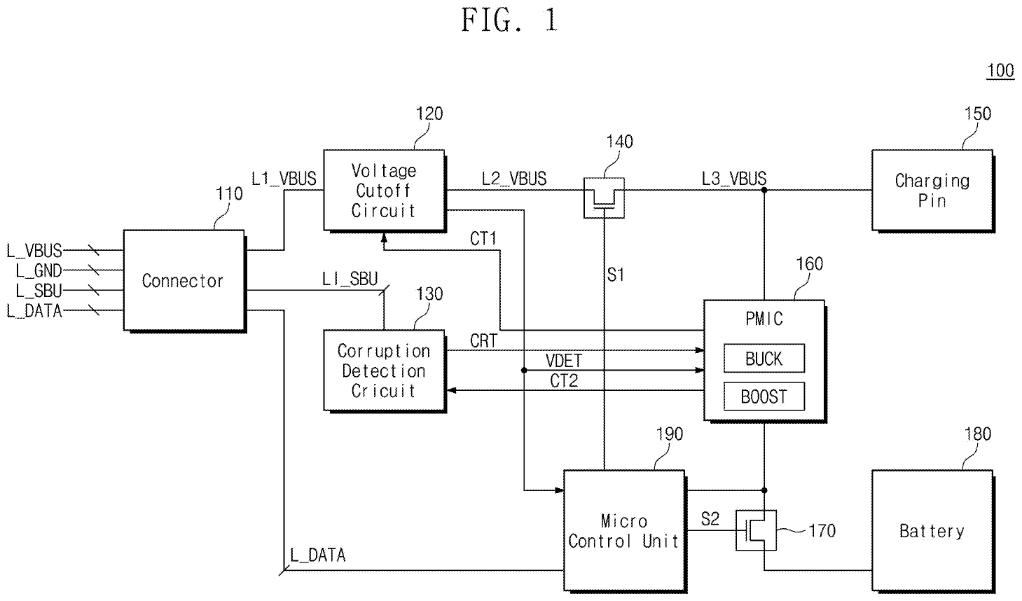

FIG. 1 is a diagram illustrating an electronic device 100 according to an embodiment of the present disclosure. In an embodiment, the electronic device 100 may be implemented with a true wireless stereo (TWS) cradle. Referring to FIG. 1, the electronic device 100 may include a connector 110, a voltage cutoff circuit 120, a corruption detection circuit 130, a first switch 140, a charging pin 150, a power management integrated circuit (PMIC) 160, a second switch 170, a battery 180, and a micro control unit 190.

The connector 110 may be connected with a first device (hereinafter referred to as a “first external device”) located outside the electronic device 100. For example, the connector 110 may be a receptacle or a USB Type-C receptacle. The connector 110 may include terminals for connecting with various lines of the first external device, which include voltage lines L_VBUS, ground lines L_GND, auxiliary lines L_SBU, and data lines L_DATA.

The connector 110 may connect a voltage (e.g., VBUS) transferred through the voltage lines L_VBUS of the first external device with a first voltage line L1_VBUS in the electronic device 100. The connector 110 may transfer a ground voltage transferred through the ground lines L_GND of the first external device to a ground node of the electronic device 100. The connector 110 may connect signals transferred through the auxiliary lines L_SBU of the first external device with auxiliary voltage lines LI_SBU in the electronic device 100. The connector 110 may connect signals transferred through the data lines L_DATA of the first external device with data lines LI_DATA in the electronic device 100.

The voltage cutoff circuit 120 may be connected between the first voltage line L1_VBUS and a second voltage line L2_VBUS. The voltage cutoff circuit 120 may operate in response to a first control signal CT1 received from the power management integrated circuit 160. The voltage cutoff circuit 120 may block or establish an electrical connection between the first voltage line L1_VBUS and the second voltage line L2_VBUS in response to the first control signal CT1.

The voltage cutoff circuit 120 may detect whether an external voltage is supplied from the first external device to the first voltage line L1_VBUS through the connector 110. When the external voltage is supplied to the first voltage line L1_VBUS, the voltage cutoff circuit 120 may activate a detection signal VDET. For example, the detection signal VDET with a high level may be applied to the PMIC 160. When the external voltage is not supplied to the first voltage line L1_VBUS, the voltage cutoff circuit 120 may deactivate the detection signal VDET. For example, the detection signal VDET with a low level may be applied to the PMIC 160.

The corruption detection circuit 130 may receive a second control signal CT2. In response to the second control signal CT2, the corruption detection circuit 130 may detect whether the connector 110 is corrupted. When the connector 110 is corrupted, the corruption detection circuit 130 may activate a corruption signal CRT. For example, the corruption signal CRT with a high level may be applied to the PMIC 160. When the connector 110 is not corrupted, the corruption detection circuit 130 may deactivate the corruption signal CRT. For example, the corruption signal CRT with a low level may be applied to the PMIC 160.

The first switch 140 may operate in response to a first signal S1 received from the micro control unit 190. In response to the first signal S1, the first switch 140 may electrically connect the second voltage line L2_VBUS and a third voltage line L3_VBUS or may electrically disconnect the second voltage line L2_VBUS from the third voltage line L3_VBUS.

The charging pin 150 may be configured to be connected with a second device (hereinafter referred to as a “second external device”) located outside of the electronic device 100. For example, the charging pin 150 may be connected with wireless earphones. When the second external device is connected, the charging pin 150 may provide a voltage of the third voltage line L3_VBUS to the second external device to enable charging of the second external device. For example, the charging pin 150 may include two or more charging pins.

The power management integrated circuit 160 may receive the detection signal VDET from the voltage cutoff circuit 120. When the external voltage is transferred to the third voltage line L3_VBUS, the power management integrated circuit 160 may step down the voltage of the third voltage line L3_VBUS, may charge the battery 180 with the stepped-down voltage, and may power the micro control unit 190. When the external voltage is not transferred to the third voltage line L3_VBUS, the power management integrated circuit 160 may step up the voltage of the third voltage line L3_VBUS and may supply the stepped-up voltage to the charging pin 150.

The power management integrated circuit 160 may include a buck converter BUCK configured to step down a voltage and a boost converter BOOST configured to step up a voltage. The power management integrated circuit 160 may receive the detection signal VDET from the voltage cutoff circuit 120 through a general purpose input and output (GPIO) and may transfer the first control signal CT1 to the voltage cutoff circuit 120.

When the corruption signal CRT received from the corruption detection circuit 130 is activated (e.g., when the corruption signal CRT has an active level), the power management integrated circuit 160 may control the voltage cutoff circuit 120 with the first control signal CT1 such that the first voltage line L1_VBUS and the second voltage line L2_VBUS are electrically disconnected. When the corruption signal CRT received from the corruption detection circuit 130 is deactivated (e.g., when the corruption signal CRT has an inactive level), the power management integrated circuit 160 may control the voltage cutoff circuit 120 with the first control signal CT1 such that the first voltage line L1_VBUS and the second voltage line L2_VBUS are electrically connected.

The second switch 170 may operate in response to a second signal S2 received from the micro control unit 190. In response to the second signal S2, the second switch 170 may electrically connect the power management integrated circuit 160 and the battery 180 or may electrically disconnect the power management integrated circuit 160 from the battery 180.

The battery 180 may operate under control of the power management integrated circuit 160. The battery 180 may be charged by the voltage transferred from the power management integrated circuit 160. The battery 180 may output the charged voltage under control of the power management integrated circuit 160.

The micro control unit 190 may control various operations of the electronic device 100. The micro control unit 190 may be reset when the detection signal VDET is activated. The micro control unit 190 may control the first switch 140 with the first signal SL. The micro control unit 190 may control the second switch 170 with the second signal S2.

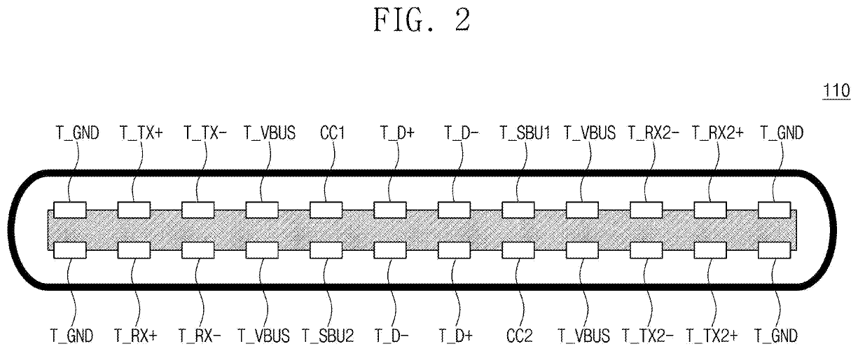

The first switch 140 or the second switch 170 which may be implemented as, for example, a transistor, may have a parasitic diode in a turn-off state. A leakage current may flow due to the parasitic diode. When a parasitic current flows when the connector 110 is corrupted, the connector 110 may be further corroded. The higher a voltage of a voltage terminal T_VBUS (refer to FIG. 2) of the connector 110, the faster the corrosion of the connector 110. To prevent the corrosion due to the parasitic current, the voltage cutoff circuit 120 may be designed to suppress the leakage current. For example, the voltage cutoff circuit 120 may be implemented with an over voltage protection (OVP) circuit. The voltage cutoff circuit 120 may be manufactured with a separate integrated circuit.

When the external voltage is transferred to the third voltage line L3_VBUS, the electronic device 100 may transfer the external voltage to the second external device through the charging pin 150. Because DC-DC conversion such as step-up conversion and step-down conversion is not performed in the process of providing the voltage to the second external device, the electronic device 100 may charge the second external device with high efficiency.

FIG. 2 illustrates an example of the connector 110. Referring to FIGS. 1 and 2, the connector 110 may be based on USB Type-C. Ground terminals T_GND may be connected to the ground lines L_GND of the first external device. Transmit terminals T_TX+ and T_TX−, second transmit terminals T_TX2+ and T_TX2−, receive terminals T_RX+ and T_RX−, and second receive terminals T_RX2+ and T_RX2− are connected with the data lines L_DATA of the first external device. Compatible terminals T_D+ and T_D− may support USB 2.0.

The voltage terminals T_VBUS may be connected with the voltage lines L_VBUS of the first external device. Auxiliary terminals T_SBU1 and T_SBU2 may be connected with the auxiliary lines L_SBU of the first external device. Channel configuration terminals CC1 and CC2 may be used to configure a channel with the first external device.

When the electronic device 100 is implemented with the TWS cradle, the use of the electronic device 100 is limited to basic functions such as a function of charging the second external device, for example, wireless earphones. Accordingly, the electronic device 100 may not communicate with the first external device through the auxiliary terminals T_SBU1 and T_SBU2. The electronic device 100 may use the auxiliary terminals T_SBU1 and T_SBU2 as detection terminals for detecting contaminants.

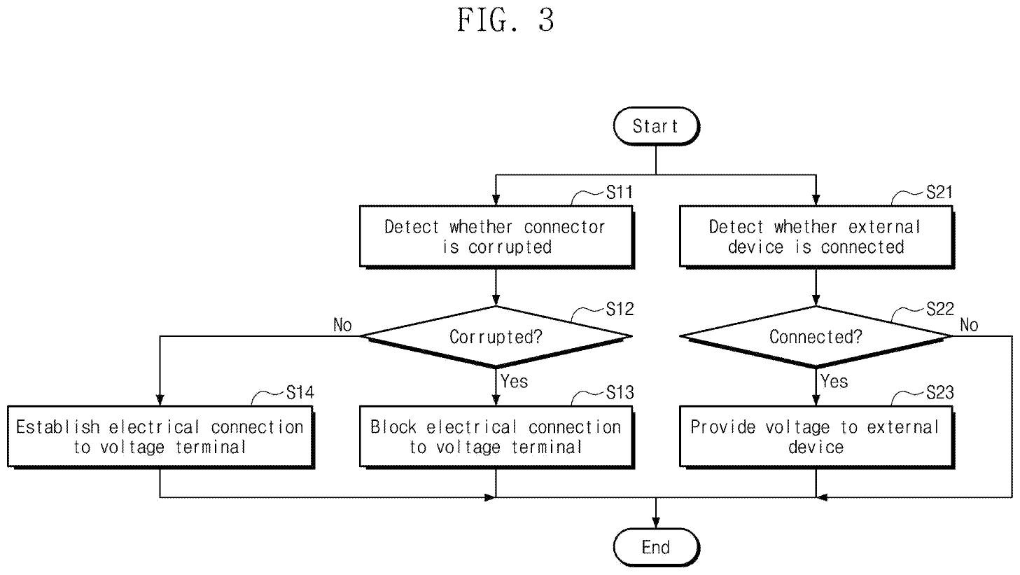

FIG. 3 is a diagram illustrating an example of an operating method of the electronic device 100. Referring to FIGS. 1 and 3, the electronic device 100 may perform corruption management of the connector 110 through operation S11, operation S12, operation S13, and operation S14 and may perform charging management of the second external device through operation S21, operation S22, and operation S23 that are independent of or parallel to operation S11, operation S12, operation S13, and operation S14.

In operation S11, the electronic device 100 may detect whether the connector 110 is corrupted. The electronic device 100 may periodically perform the detection. For example, the power management integrated circuit 160 may detect that the connector 110 is corrupted by monitoring the activation of the corruption signal CRT. Additionally, the power management integrated circuit 160 may detect that the connector 110 is not corrupted (e.g., the connector 110 is clean) by monitoring the deactivation (or maintenance of an inactive state) of the corruption signal CRT.

As another example, the power management integrated circuit 160 may detect the corruption of the connector 110 when an activation pattern of the corruption signal CRT at different detection timings satisfies a given condition. After the corruption of the connector 110 is detected, if the corruption signal CRT remains deactivated or in the inactive state for two or more detection timings, the power management integrated circuit 160 may detect that the corruption of the connector 110 is resolved, indicating that the connector 110 is no longer corrupted.

When it is detected in operation S12 that the connector 110 is corrupted, in operation S13, the electronic device 100 may block the electrical connection with the voltage terminal T_VBUS. For example, the power management integrated circuit 160 may control the first control signal CT1 to activate the voltage cutoff circuit 120. The activated voltage cutoff circuit 120 may electrically disconnect the first voltage line L1_VBUS from the second voltage line L2_VBUS.

When it is detected in operation S12 that the connector 110 is not corrupted, for example, when it is detected that the corruption of the connector 110 is resolved after the connector 110 was corrupted, in operation S14, the electronic device 100 may establish the electrical connection with the voltage terminal T_VBUS. For example, the power management integrated circuit 160 may control the first control signal CT1 to deactivate the voltage cutoff circuit 120. The deactivated voltage cutoff circuit 120 may establish the electrical connection of the first voltage line L1_VBUS and the second voltage line L2_VBUS.

In operation S21, the electronic device 100 may detect whether the second external device is connected with the charging pin 150. When it is detected in operation S22 that the second external device is connected with the charging pin 150, in operation S23, the electronic device 100 may provide the voltage to the second external device. For example, the charging pin 150 may provide the voltage of the third voltage line L3_VBUS to the second external device. When it is detected in operation S22 that the second external device is not connected with the charging pin 150, the electronic device 100 may leave the charging pin 150 unused.

As described above, when the connector 110 is corrupted, the electronic device 100 may block the external voltage by using the separate voltage cutoff circuit 120. Regardless of whether the connector 110 is corrupted or not, the electronic device 100 may charge the second external device as long as the second external device is connected with the charging pin 150.

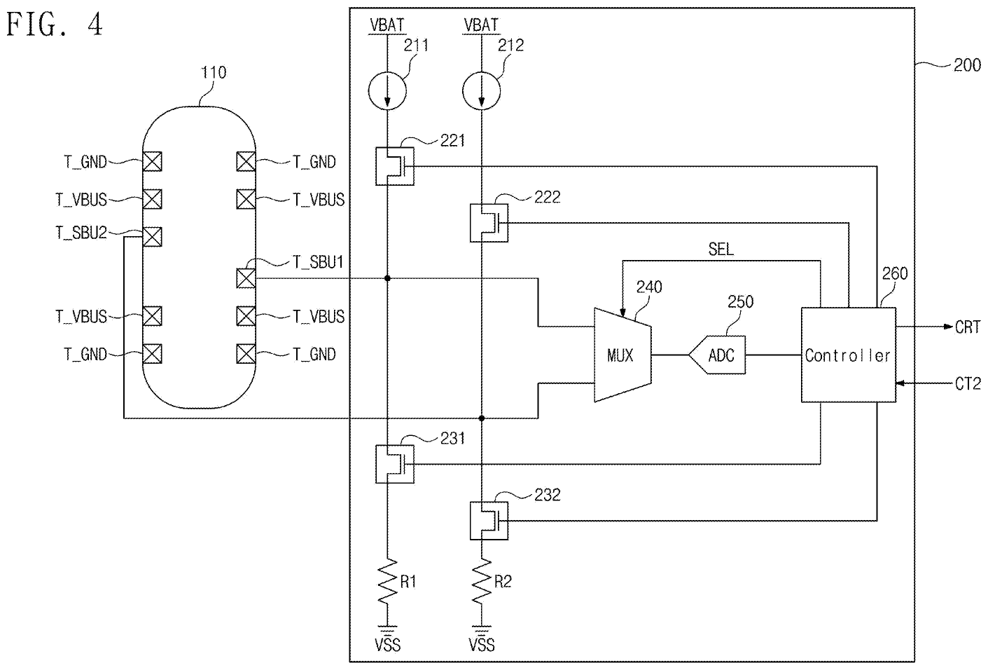

FIG. 4 is a diagram illustrating an example of the connector 110 and a corruption detection circuit 200. The corruption detection circuit 200 may correspond to the corruption detection circuit 130 of FIG. 1. The voltage terminals T_VBUS, ground terminals T_GND, a first auxiliary terminal T_SBU1, and a second auxiliary terminal T_SBU2 of the connector 110 are illustrated in FIG. 4.

The corruption detection circuit 200 may include a first current source 211, a second current source 212, a first pull-up switch 221, a second pull-up switch 222, a first pull-down switch 231, a second pull-down switch 232, a multiplexer 240, an analog-to-digital converter (ADC) 250, and a controller 260.

The first current source 211 may be connected between a node to which a battery voltage VBAT of the battery 180 (refer to FIG. 1) is supplied and the first pull-up switch 221. The second current source 212 may be connected between the node to which the battery voltage VBAT is supplied and the second pull-up switch 222.

The first pull-up switch 221 may be connected between the first current source 211 and the first auxiliary terminal T_SBU1. The first pull-up switch 221 may be turned on or turned off under control of the controller 260. For example, the controller 260 may provide an on or off signal to a gate of the first pull-up switch 221. The second pull-up switch 222 may be connected between the second current source 212 and the second auxiliary terminal T_SBU2. The second pull-up switch 222 may be turned on or turned off under control of the controller 260. For example, the controller 260 may provide an on or off signal to a gate of the second pull-up switch 222.

A first resistor R1 may be connected between the first pull-down switch 231 and a ground node to which a ground voltage VSS is supplied. A second resistor R2 may be connected between the second pull-down switch 232 and the ground node to which the ground voltage VSS is supplied.

The first pull-down switch 231 may be connected between the first auxiliary terminal T_SBU1 and the first resistor R1. The first pull-down switch 231 may be turned on or turned off under control of the controller 260. For example, the controller 260 may provide an on or off signal to a gate of the first pull-down switch 231. The second pull-down switch 232 may be connected between the second auxiliary terminal T_SBU2 and the second resistor R2. The second pull-down switch 232 may be turned on or turned off under control of the controller 260. For example, the controller 260 may provide an on or off signal to a gate of the second pull-down switch 232.

The multiplexer 240 may transfer one of the voltage of the first auxiliary terminal T_SBU1 and the voltage of the second auxiliary terminal T_SBU2 to the analog-to-digital converter 250 in response to a selection signal SEL received from the controller 260. For example, the multiplexer 240 may be an analog multiplexer.

The analog-to-digital converter 250 may convert the voltage level output from the multiplexer 240 into a digital value. The analog-to-digital converter 250 may output the converted digital value to the controller 260.

The controller 260 may enter the detection timing in response to the second control signal CT2. The second control signal CT2 may be provided from the PMIC 160 (refer to FIG. 1). At the detection timing, the controller 260 may perform pull-up detection by activating the first pull-up switch 221 and the second pull-up switch 222 or may perform pull-down detection by activating the first pull-down switch 231 and the second pull-down switch 232. The controller 260 may control the selection signal SEL such that the multiplexer 240 alternately outputs the voltage of the first auxiliary terminal T_SBU1 and the voltage of the second auxiliary terminal T_SBU2.

The controller 260 may receive the digital value from the analog-to-digital converter 250. For example, the controller 260 may sequentially receive the digital value corresponding to the voltage of the first auxiliary terminal T_SBU1 and the digital value corresponding to the voltage of the second auxiliary terminal T_SBU2 from the analog-to-digital converter 250.

The controller 260 may determine whether each of the digital values indicates a corruption state. When any one of the digital values indicates the corruption state, the controller 260 may activate the corruption signal CRT. When both of the digital values do not indicate the corruption state, the controller 260 may deactivate the corruption signal CRT.

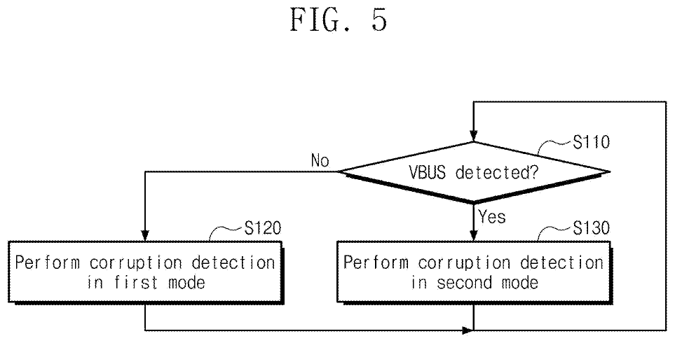

FIG. 5 is a diagram illustrating an example in which the electronic device 100 performs corruption detection in different manners. Referring to FIGS. 1, 4, and 5, in operation S110, the electronic device 100 may determine whether an external voltage VBUS is detected. For example, when the detection signal VDET is in an inactive state, the power management integrated circuit 160 may determine that the external voltage VBUS is not detected. In operation S120, the power management integrated circuit 160 may control the corruption detection circuit 130 through the second control signal CT2 such that corruption detection is performed in a first mode. For example, in the first mode, the corruption detection circuit 130 may perform corruption detection in a pull-up manner.

When the detection signal VDET is in an active state, the power management integrated circuit 160 may determine that the external voltage VBUS is detected. In operation S130, the power management integrated circuit 160 may control the corruption detection circuit 130 through the second control signal CT2 such that corruption detection is performed in a second mode. For example, in the second mode, the corruption detection circuit 130 may perform corruption detection in a pull-down manner.

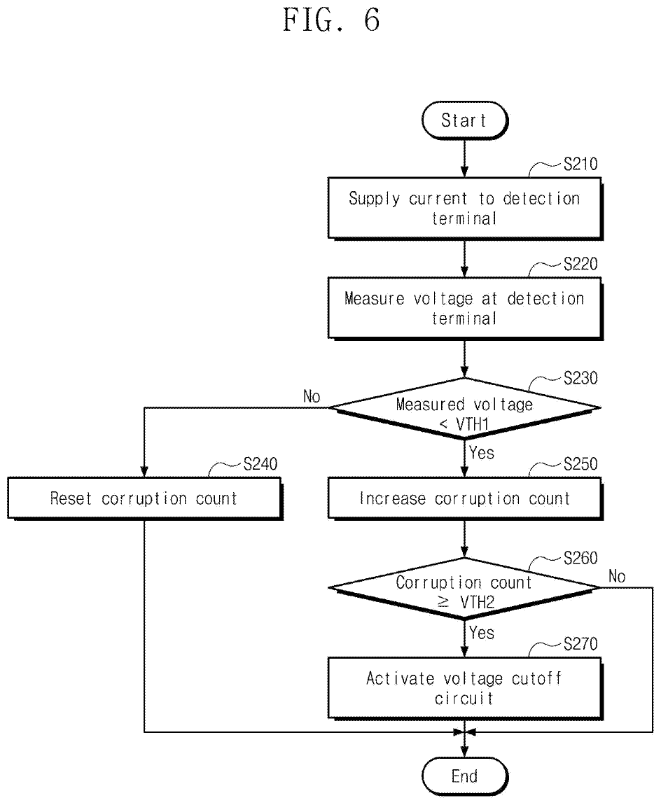

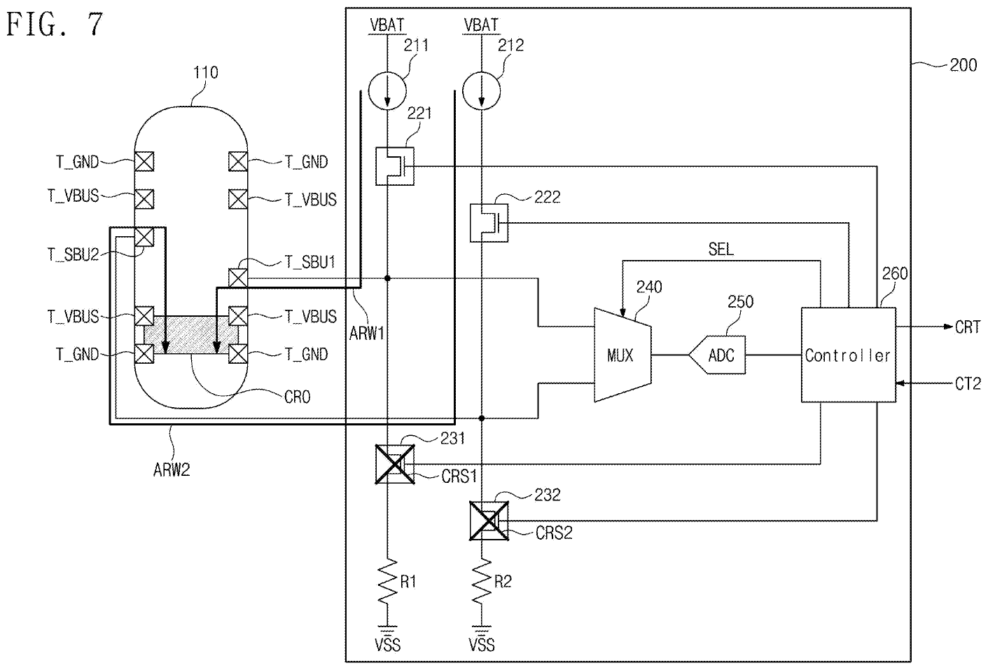

FIG. 6 is a diagram illustrating an example in which the electronic device 100 performs corruption detection in a pull-up manner. FIG. 7 is a diagram illustrating a process in which corruption detection of a pull-up manner is performed in the connector 110 and the corruption detection circuit 200 according to a method of FIG. 6.

Referring to FIGS. 1, 6, and 7, as marked by a first cross CRS1, a second cross CRS2, a first arrow ARW1, and a second arrow ARW2, the corruption detection circuit 130 may turn on the first pull-up switch 221 and the second pull-up switch 222 and may turn off the first pull-down switch 231 and the second pull-down switch 232; in this case, in operation S210, the corruption detection circuit 200 may supply a current to a detection terminal (e.g., including the first auxiliary terminal T_SBU1 and the second auxiliary terminal T_SBU2).

In operation S220, the corruption detection circuit 130 may measure a voltage of the detection terminal (e.g., including the first auxiliary terminal T_SBU1 and the second auxiliary terminal T_SBU2). As illustrated in FIG. 7, when an electrical path is formed between the first auxiliary terminal T_SBU1 or the second auxiliary terminal T_SBU2 and the ground terminal T_GND due to a contaminant CRO, a current may be leaked out due to the contaminant CRO, and thus, the voltage of the first auxiliary terminal T_SBU1 or the second auxiliary terminal T_SBU2 may decrease.

In operation S230, the controller 260 may determine whether the measured voltage is smaller than a first threshold value VTH1. In an embodiment, each of the first current source 211 and the second current source 212 may output a current of 1 μA. When the voltage of the first auxiliary terminal T_SBU1 or the second auxiliary terminal T_SBU2 is smaller than 650 mV, the controller 260 may determine that the contaminant CRO exists and may activate the corruption signal CRT.

When the measured voltage is smaller than the first threshold value VTH1 (e.g., 650 mV), and the corruption signal CRT is activated, in operation S250, the power management integrated circuit 160 may increase a corruption count. In operation S260, the power management integrated circuit 160 may determine whether the corruption count is equal to or greater than a second threshold value VTH2. When the corruption count is equal to or greater than the second threshold value VTH2, in operation S270, the power management integrated circuit 160 may activate the voltage cutoff circuit 120. When the corruption count is smaller than the second threshold value VTH2, the power management integrated circuit 160 may not activate the voltage cutoff circuit 120.

When the measured voltage is not smaller than the first threshold value VTH1 (e.g., 650 mV), in other words, when the measured voltage is equal to or greater than the first threshold value VTH1, in operation S240, the power management integrated circuit 160 may reset the corruption count.

The electronic device 100 may periodically perform the corruption detection of FIG. 6 when the connector 110 is not corrupted and the external voltage VBUS does not exist. The corruption detection of FIG. 6 may be performed, for example, at a period of 20 ms. When corruption is detected as much as and more than the second threshold value VTH2, the electronic device 100 may determine the presence of corruption and activate the voltage cutoff circuit 120. In an embodiment, the second threshold value VTH2 may be “3”.

In FIGS. 6 and 7, the description is given that the corruption detection circuit 200 turns on the first pull-up switch 221 and the second pull-up switch 222 at the same time. However, the corruption detection circuit 200 may alternately turn on the first pull-up switch 221 and the second pull-up switch 222, during corruption detection. For example, the controller 260 may turn on the first pull-up switch 221 and may control the multiplexer 240 such that the voltage of the first auxiliary terminal T_SBU1 is output. Afterwards, the controller 260 may turn on the second pull-up switch 222 and may control the multiplexer 240 such that the voltage of the second auxiliary terminal T_SBU2 is output. The timing to turn on the first pull-up switch 221 and the second pull-up switch 222 and the timing to control the multiplexer 240 may be performed in reverse order.

As another example, during corruption detection, the corruption detection circuit 200 may activate just one of the first pull-up switch 221 and the second pull-up switch 222. In other words, the corruption detection circuit 200 may perform corruption detection by using just one of the first auxiliary terminal T_SBU1 and the second auxiliary terminal T_SBU2.

As another example, the corruption detection circuit 200 may perform the corruption detection while alternately selecting the first auxiliary terminal T_SBU1 and the second auxiliary terminal T_SBU2 at different detection timings (e.g., at consecutive detection timings).

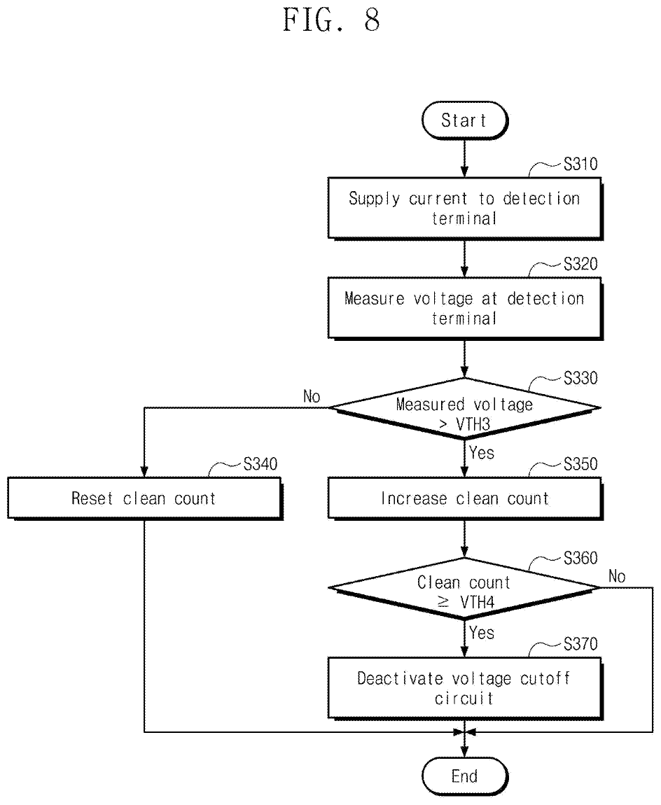

FIG. 8 is a diagram illustrating an example in which after the connector 110 is corrupted, the electronic device 100 detects whether the corruption is removed in a pull-up manner. Referring to FIGS. 1, 7, and 8, in operation S310, the corruption detection circuit 130 or 200 may supply a current to a detection terminal. In operation S320, the corruption detection circuit 130 or 200 may measure a voltage at a detection terminal. Operation S310 and operation S320 may be identical to operation S210 and operation S220 of FIG. 6. The description given with reference to operation S210 and operation S210 of FIG. 6 may be identically applied to operation S310 and operation S320 of FIG. 8.

In operation S330, the controller 260 of the corruption detection circuit 130 or 200 determines whether the measured voltage is greater than a third threshold value VTH3. When the voltage of the first auxiliary terminal T_SBU1 or the second auxiliary terminal T_SBU2 is greater than 850 mV, the controller 260 may determine that the contaminant CRO is removed and may deactivate the corruption signal CRT.

When the measured voltage is greater than the third threshold value VTH3 (e.g., 850 mV), in response to deactivation of the corruption signal CRT, in operation S350, the power management integrated circuit 160 may increase a clean count. In operation S360, the power management integrated circuit 160 may determine whether the clean count is equal to or greater than a fourth threshold value VTH4. When the clean count is equal to or greater than the fourth threshold value VTH4, in operation S370, the power management integrated circuit 160 may deactivate the voltage cutoff circuit 120. When the clean count is smaller than the fourth threshold value VTH4, the power management integrated circuit 160 may not deactivate the voltage cutoff circuit 120.

When the measured voltage is not greater than the third threshold value VTH3 (e.g., 850 mV), in other words, when the measured voltage is equal to or smaller than the fourth threshold value VTH4, in operation S340, the power management integrated circuit 160 may reset the clean count.

The electronic device 100 may periodically perform the corruption removal detection of FIG. 8 when the connector 110 is corrupted and the external voltage VBUS does not exist. The corruption removal detection of FIG. 8 may be performed, for example, at a period of 10 s. When the clean count is equal to or exceeds the fourth threshold value VTH4, the electronic device 100 may determine that the connector 110 is no longer corrupted and may deactivate the voltage cutoff circuit 120. In an embodiment, the fourth threshold value VTH4 may be “3”.

As described with reference to FIG. 6, the corruption detection circuit 200 may perform corruption removal detection by alternately activating the first pull-up switch 221 and the second pull-up switch 222, by activating one of the first pull-up switch 221 and the second pull-up switch 222, or by alternately activating the first pull-up switch 221 and the second pull-up switch 222 at different detection timings.

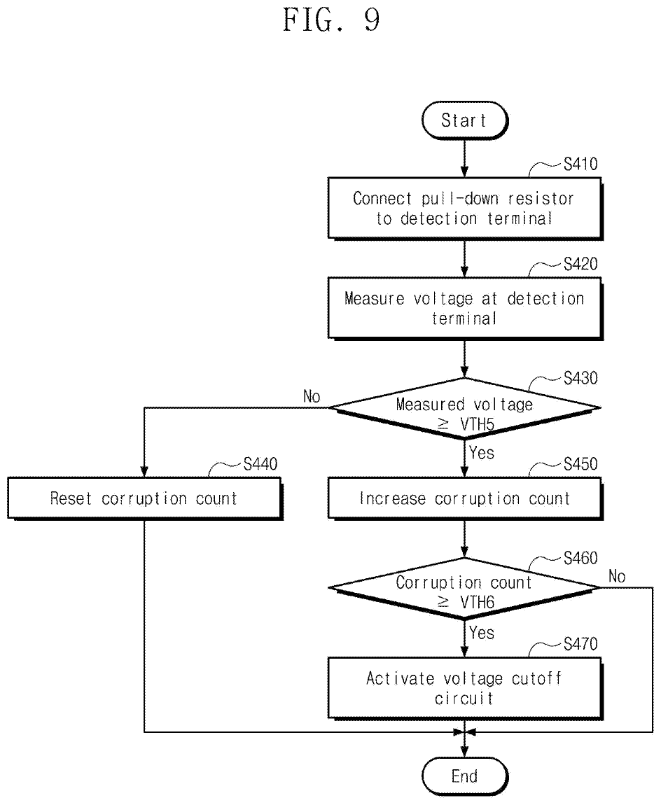

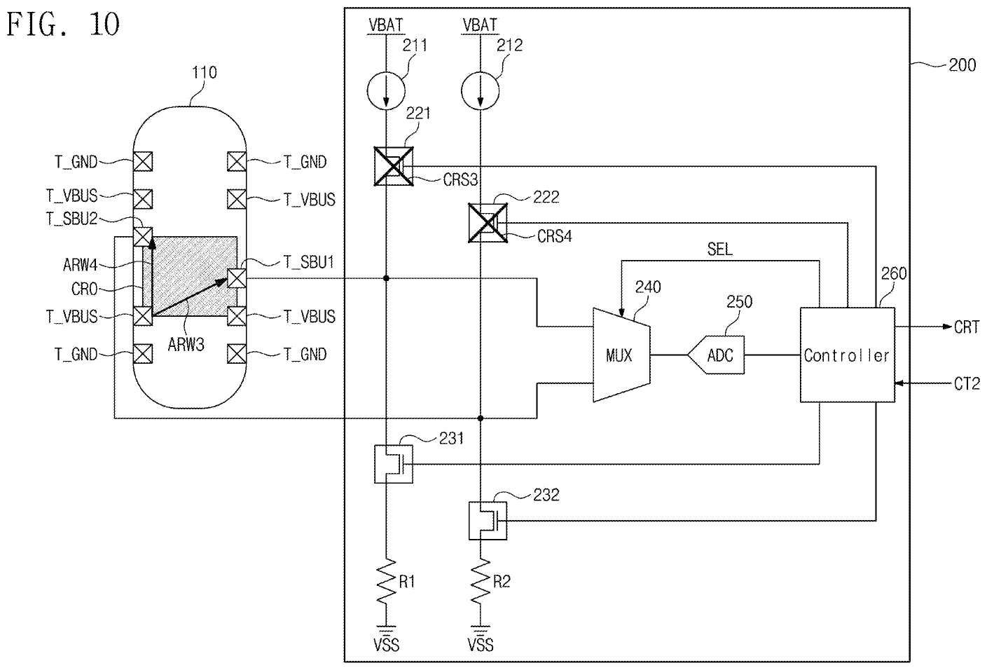

FIG. 9 is a diagram illustrating an example in which the electronic device 100 performs corruption detection in a pull-down manner. FIG. 10 is a diagram illustrating a process in which corruption detection of a pull-down manner is performed in the connector 110 and the corruption detection circuit 200 according to a method of FIG. 9.

Referring to FIGS. 1, 9, and 10, as marked by a third cross CRS3, a fourth cross CRS4, a third arrow ARW3, and a fourth arrow ARW4, the corruption detection circuit 200 may turn on the first pull-down switch 231 and the second pull-down switch 232 and may turn off the first pull-up switch 221 and the second pull-up switch up 222; in this case, in operation S410, the corruption detection circuit 200 may connect a pull-down resistor (e.g., including the first resistor R1 and the second resistor R2) with a detection terminal (e.g., including the first auxiliary terminal T_SBU1 and the second auxiliary terminal T_SBU2).

In operation S420, the corruption detection circuit 130 may measure a voltage of the detection terminal (e.g., including the first auxiliary terminal T_SBU1 and the second auxiliary terminal T_SBU2). As illustrated in FIG. 10, when an electrical path is formed between at least one of the voltage terminals T_VBUS and the first auxiliary terminal T_SBU1 or the second auxiliary terminal T_SBU2 due to the contaminant CRO, a current may flow due to the contaminant CRO, and thus, the voltage of the first auxiliary terminal T_SBU1 or the second auxiliary terminal T_SBU2 may increase.

In operation S430, the controller 260 may determine whether the measured voltage is equal to or higher than a fifth threshold value VTH5. In an embodiment, each of the first resistor R1 and the second resistor R2 may have a resistance value of 2 MΩ. When the voltage of the first auxiliary terminal T_SBU1 or the second auxiliary terminal T_SBU2 is equal than or greater than 500 mV, the controller 260 may determine that the contaminant CRO exists and may activate the corruption signal CRT.

When the measured voltage is equal to or than the fifth threshold value VTH5 (e.g., 500 mV), in response to the activation of the corruption signal CRT, in operation S450, the power management integrated circuit 160 may increase a corruption count. In operation S460, the power management integrated circuit 160 may determine whether the corruption count is equal to or greater than a sixth threshold value VTH6. When the corruption count is equal to or greater than the sixth threshold value VTH6, in operation S470, the power management integrated circuit 160 may activate the voltage cutoff circuit 120. When the corruption count is smaller than the sixth threshold value VTH6, the power management integrated circuit 160 may not activate the voltage cutoff circuit 120.

When the measured voltage is not equal to or greater than the fifth threshold value VTH5 (e.g., 500 mV), in other words, when the measured voltage is smaller than the fifth threshold value VTH5, in operation S440, the power management integrated circuit 160 may reset the corruption count.

The electronic device 100 may periodically perform the corruption detection of FIG. 9 in a state where the connector 110 is not corrupted and the external voltage VBUS exists. The corruption detection of FIG. 9 may be performed, for example, at a period of 20 ms. If the corruption count is equal to or greater than the sixth threshold value VTH6, the electronic device 100 will determine that corruption is present and activate the voltage cutoff circuit 120. In an embodiment, the sixth threshold value VTH6 may be “3”.

In FIGS. 9 and 10, the description is given that the corruption detection circuit 200 turns on the first pull-down switch 231 and the second pull-down switch 232 at the same time. However, the corruption detection circuit 200 may alternately turn on the first pull-down switch 231 and the second pull-down switch 232, during corruption detection. For example, the controller 260 may turn on the first pull-down switch 231 and may control the multiplexer 240 such that the voltage of the first auxiliary terminal T_SBU1 is output. Afterwards, the controller 260 may turn on the second pull-down switch 232 and may control the multiplexer 240 such that the voltage of the second auxiliary terminal T_SBU2 is output. The timing to turn on the first pull-down switch 231 and the second pull-down switch 232 and the timing to control the multiplexer 240 may be performed in reverse order.

As another example, at the detection timing, the corruption detection circuit 200 may activate one of the first pull-down switch 231 and the second pull-down switch 232 and may not activate the other of the first pull-down switch 231 and the second pull-down switch 232. In other words, the corruption detection circuit 200 may perform the corruption detection by using one of the first auxiliary terminal T_SBU1 and the second auxiliary terminal T_SBU2.

As another example, the corruption detection circuit 200 may perform the corruption detection while alternately selecting the first auxiliary terminal T_SBU1 and the second auxiliary terminal T_SBU2 at different detection timings (e.g., at consecutive detection timings).

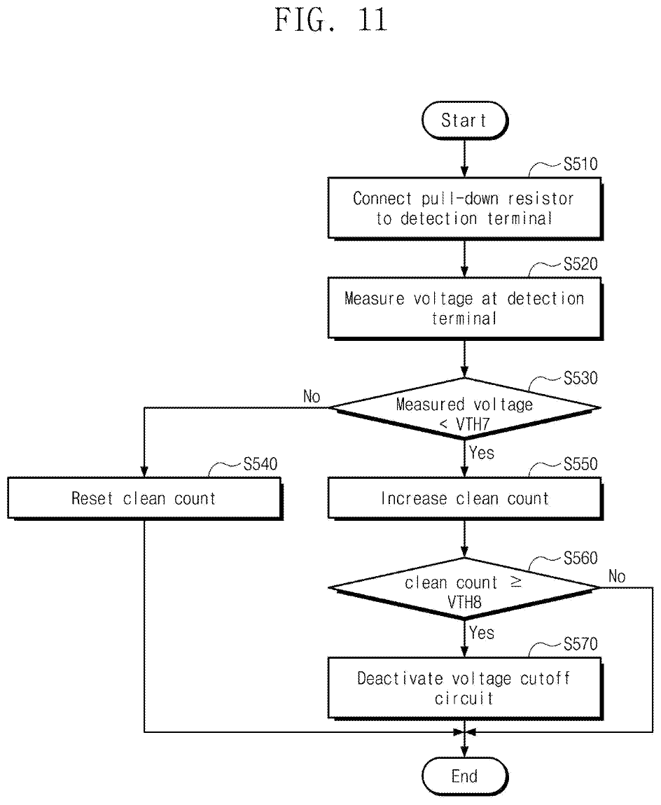

FIG. 11 is a diagram illustrating an example in which after the connector 110 is corrupted, the electronic device 100 detects whether the corruption is removed in a pull-down manner. Referring to FIGS. 1, 10, and 11, in operation S510, the corruption detection circuit 130 or 200 may connect a detection terminal with a pull-down resistor. In operation S520, the corruption detection circuit 130 or 200 may measure a voltage at the detection terminal. Operation S510 and operation S520 may be identical to operation S410 and operation S420 of FIG. 9. The description given with reference to operation S410 and operation S420 of FIG. 9 may be identically applied to operation S510 and operation S520 of FIG. 11.

In operation S530, the corruption detection circuit 130 or 200, in other words, the controller 260 may determine whether the measured voltage is smaller than a seventh threshold value VTH7. When the voltage of the first auxiliary terminal T_SBU1 or the second auxiliary terminal T_SBU2 is smaller than 300 mV, the controller 260 may determine that the contaminant CRO is removed and may deactivate the corruption signal CRT.

When the measured voltage is smaller than the seventh threshold value VTH7 (e.g., 300 mV), in response to the deactivation of the corruption signal CRT, in operation S550, the power management integrated circuit 160 may increase a clean count. In operation S560, the power management integrated circuit 160 may determine whether the clean count is equal to or greater than an eighth threshold value VTH8. When the clean count is equal to or greater than the eighth threshold value VTH8, in operation S570, the power management integrated circuit 160 may deactivate the voltage cutoff circuit 120. When the clean count is smaller than the eighth threshold value VTH8, the power management integrated circuit 160 may not deactivate the voltage cutoff circuit 120.

When the measured voltage is not smaller than the seventh threshold value VTH7 (e.g., 300 mV), in other words, when the measured voltage is equal to or greater than the eighth threshold value VTH8, in operation S540, the power management integrated circuit 160 may reset the clean count.

The electronic device 100 may periodically perform the corruption removal detection of FIG. 11 in a state where the connector 110 is corrupted and the external voltage VBUS exists. The corruption removal detection of FIG. 11 may be performed, for example, at a period of 10 s. When the clean count continues to be detected as much as or greater than the eighth threshold value VTH8, the electronic device 100 may determine that the connector 110 is no longer corrupted and deactivate the voltage cutoff circuit 120. In an embodiment, the eighth threshold value VTH8 may be “3”.

Like that described with reference to FIG. 9, as pertains to FIG. 11, the corruption detection circuit 200 may perform corruption removal detection by alternately activating the first pull-down switch 231 and the second pull-down switch 232, by activating one of the first pull-down switch 231 and the second pull-down switch 232, or by alternately activating the first pull-down switch 231 and the second pull-down switch 232 at different detection timings.

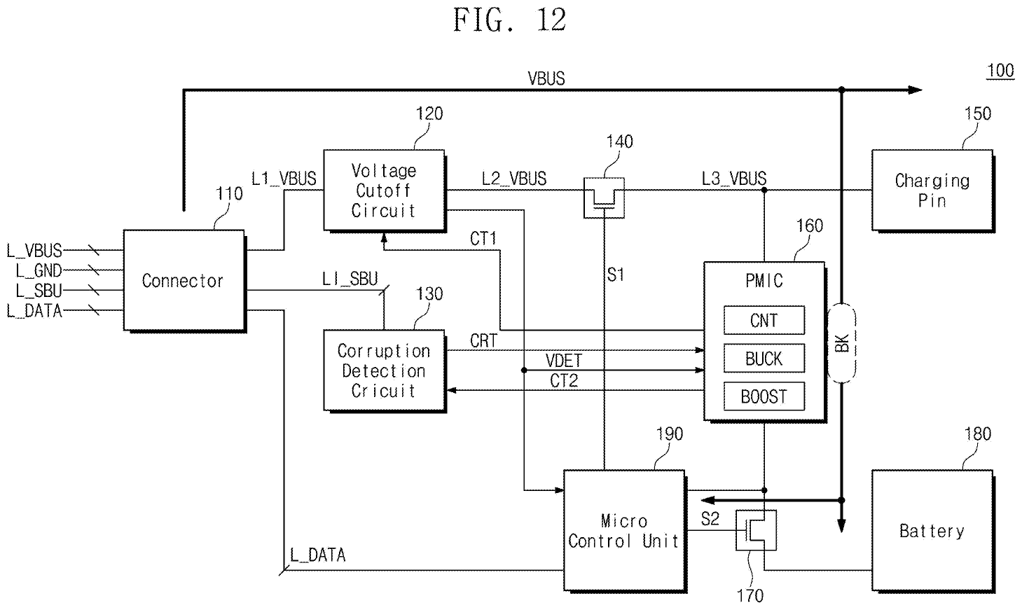

FIG. 12 is a diagram illustrating an example in which the electronic device 100 operates when the external voltage VBUS exists and the connector 110 is not corrupted. Referring to FIG. 12, the electronic device 100 may provide the external voltage VBUS to the second external device through the charging pin 150. Because the external voltage VBUS is provided to the second external device without step-up or step-down conversion, the efficiency at which the second external device is charged is improved. In addition, by using the external voltage VBUS (e.g., by stepping down (or buck converting BK) the external voltage VBUS), the electronic device 100 may power the micro control unit 190 and may charge the battery 180. FIG. 12 further illustrates that the PMIC 160 includes a counter CNT. The counter CNT is used to increase the clean count and the corruption count in the methods described above.

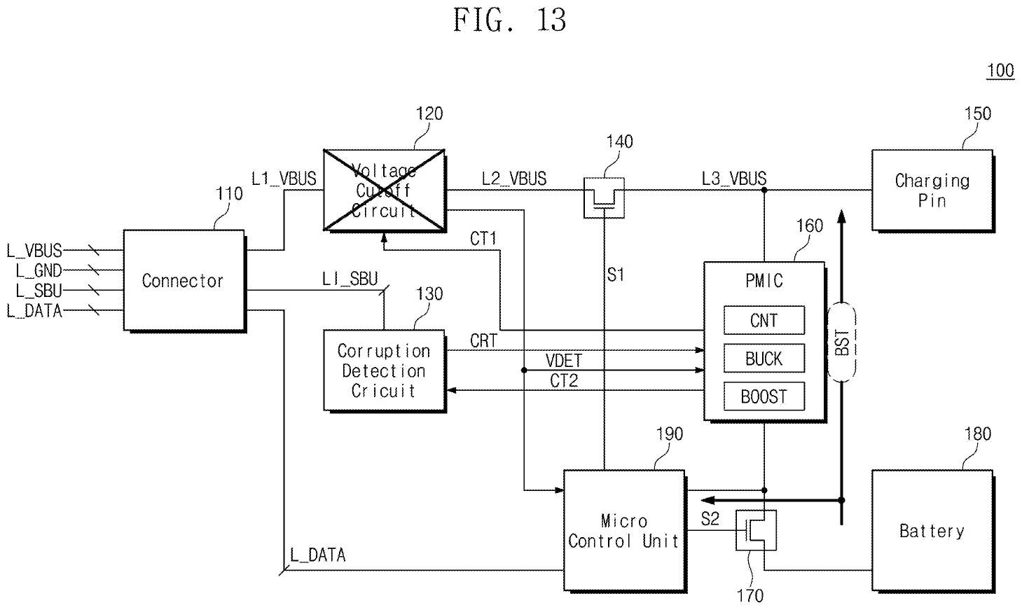

FIG. 13 is a diagram illustrating an example in which the electronic device 100 operates when the connector 110 is corrupted. The electronic device 100 may activate the voltage cutoff circuit 120 irrespective of whether the external voltage VBUS exists. The electronic device 100 may supply the power to the micro control unit 190 by using the voltage charged in the battery 180 and may power the second external device by using the voltage charged in the battery 180 (e.g., by stepping up (or boost converting BST) the voltage).

Since the voltage cutoff circuit 120 is activated irrespective of whether the external voltage VBUS exists, even though the first external device is connected with the connector 110 and the external voltage VBUS starts to be newly supplied, the connector 110 may be prevented from being corroded.

In the above embodiments, components according to the present disclosure are described by using the terms “first”, “second”, “third”, etc. However, the terms “first”, “second”, “third”, etc., may be used to distinguish components from each other and do not limit the present disclosure. For example, the terms “first”, “second”, “third”, etc., do not involve any particular order or a numerical meaning of any form.

In the above description, components according to embodiments of the present disclosure are referenced by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. Additionally, the blocks may include circuits implemented with semiconductor elements in an integrated circuit, or circuits functioning as an intellectual property (IP).

According to the present disclosure, an electronic device is connected with a first external device through a voltage cutoff circuit and activates the voltage cutoff circuit when corruption is detected. Accordingly, an electronic device that prevents a connector from being corroded and charges a second external device irrespective of corruption and an operating method of the electronic device are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device comprising:
a connector including a voltage terminal, a detection terminal, and a data terminal;
a battery;
a corruption detection circuit configured to detect whether the connector is corrupted;
a voltage cutoff circuit connected with the voltage terminal of the connector, and configured to electrically connect the voltage terminal with an internal node when corruption of the connector is not detected by the corruption detection circuit and to electrically disconnect the voltage terminal from the internal node when the corruption is detected by the corruption detection circuit;
a charging pin connected with the internal node, and configured to transfer a voltage of the internal node to an external device when the charging pin is connected with the external device, irrespective of whether the corruption is detected; and
a power management integrated circuit connected between the internal node and the battery, and configured to charge the battery by using the voltage of the internal node or to generate the voltage of the internal node by using a voltage of the battery.

2. The electronic device of claim 1, wherein the corruption detection circuit includes an over voltage protection (OVP) circuit.

3. The electronic device of claim 1, wherein the corruption detection circuit is configured to:
detect whether the connector is corrupted using different techniques, according to whether an external voltage is supplied through the voltage terminal.

4. The electronic device of claim 3, wherein the voltage cutoff circuit is configured to:
detect whether the external voltage is supplied through the voltage terminal; and
transfer a signal indicating that the external voltage is supplied, to the corruption detection circuit.

5. The electronic device of claim 3, wherein, when the external voltage is not supplied through the voltage terminal, the corruption detection circuit is configured to:
supply a current to the detection terminal; and
detect whether the connector is corrupted, based on a voltage of the detection terminal.

6. The electronic device of claim 5, wherein, when the voltage of the detection terminal is equal to or greater than a first threshold value, the corruption detection circuit is configured to detect that the connector is corrupted.

7. The electronic device of claim 6, wherein the corruption detection circuit is configured to:
periodically supply the current to the detection terminal; and
detect that the connector is corrupted, when the voltage of the detection terminal has been continuously measured to be equal to or greater than the first threshold value a number of times greater than or equal to a second threshold value.

8. The electronic device of claim 6, wherein, after the corruption detection circuit periodically supplies the current to the detection terminal and detects that the connector is corrupted, when the voltage of the detection terminal is smaller than a third threshold value, the corruption detection circuit determines the connector is no longer corrupted.

9. The electronic device of claim 6, wherein the corruption detection circuit periodically supplies the current to the detection terminal, and
wherein, after detecting that the connector is corrupted, the corruption detection circuit determines the connector is no longer corrupted, when the voltage of the detection terminal has been continuously measured to be smaller than a third threshold value a number of times greater than or equal to a fourth threshold value.

10. The electronic device of claim 3, wherein, when the external voltage is supplied through the voltage terminal, the corruption detection circuit is configured to:
connect the detection terminal with a ground node through a resistor; and
detect whether the connector is corrupted, based on a voltage of the detection terminal.

11. The electronic device of claim 10, wherein the corruption detection circuit is configured to:
periodically connect the detection terminal with the ground node through the resistor; and
detect that the connector is corrupted, when the voltage of the detection terminal has been continuously measured to be equal to or greater than a first threshold value a number of time greater than or equal to a second threshold value.

12. The electronic device of claim 10, wherein the corruption detection circuit periodically connects the detection terminal with the ground node through the resistor, and
wherein, after detecting that the connector is corrupted, the corruption detection circuit determines the corruption of the connector is not detected, when the voltage of the detection terminal has been continuously measured to be smaller than a third threshold value a number of times greater than or equal to a fourth threshold value.

13. The electronic device of claim 4, further comprising:
a micro control unit connected with the data terminal of the connector, and configured to receive a signal indicating whether the external voltage is supplied from the voltage cutoff circuit and to perform a reset operation when the external voltage is supplied.

14. The electronic device of claim 1, wherein, when an external voltage is supplied to the voltage terminal and the corruption is not detected by the corruption detection circuit, the charging pin is configured to transfer the external voltage to the external device, and the power management integrated circuit is configured to step down the external voltage to be transferred to the battery, and
wherein, when the external voltage is supplied to the voltage terminal and the corruption is detected by the corruption detection circuit, the power management integrated circuit is configured to transfer a voltage of the battery to the charging pin, and the charging pin is configured to transfer the voltage from the power management integrated circuit to the external device.

15. The electronic device of claim 1, wherein, when an external voltage is not applied from the voltage cutoff circuit to the internal node, the power management integrated circuit is configured to step up a voltage of the battery to be transferred to the charging pin, and the charging pin is configured to transfer the stepped-up voltage to the external device.

16. An electronic device comprising:
a connector including a voltage terminal, a detection terminal, and a data terminal;
a battery;
a corruption detection circuit configured to detect whether the connector is corrupted, using different techniques, according to whether an external voltage is supplied through the voltage terminal;
a voltage cutoff circuit connected with the voltage terminal of the connector, and configured to electrically connect the voltage terminal with an internal node when corruption of the connector is not detected by the corruption detection circuit and to electrically disconnect the voltage terminal from the internal node when the corruption is detected by the corruption detection circuit;
a power management integrated circuit configured to charge the battery by using a voltage of the internal node or to generate the voltage of the internal node by using a voltage of the battery; and
a charging pin configured to transfer the voltage of the internal node to an external device when the charging pin is connected with the external device,
wherein, when the external voltage is supplied through the voltage terminal and the corruption is not detected by the corruption detection circuit, the charging pin is configured to transfer the external voltage to the external device, and the power management integrated circuit is configured to step down the external voltage to be transferred to the battery, and
wherein, when the external voltage is supplied to the voltage terminal and the corruption is detected by the corruption detection circuit, the power management integrated circuit is configured to transfer a voltage of the battery to the charging pin, and the charging pin is configured to transfer the voltage from the power management integrated circuit to the external device.

17. The electronic device of claim 16, wherein the corruption detection circuit is configured to:
detect the corruption using a pull-up technique when the external voltage is not supplied; and
detect the corruption using a pull-down technique when the external voltage is supplied.

18. The electronic device of claim 16, wherein the electronic device is a true wireless stereo (TWS) cradle, and the connector is a universal serial bus (USB) Type-C connector.

19. An operating method of an electronic device which is configured to be connected with a first external device through a connector and is configured to be connected with a second external device through a charging pin, the method comprising:
detecting whether the connector is corrupted;
blocking an electrical connection with a voltage terminal of the connector when the connector is corrupted;
establishing the electrical connection with the voltage terminal of the connector when the connector is not corrupted; and
providing a voltage to the second external device when the second external device is connected with the charging pin, irrespective of whether the connector is corrupted.

20. The method of claim 19, wherein the detecting whether the connector is corrupted includes:
detecting whether the connector is corrupted, using a pull-down technique, when an external voltage is supplied to the voltage terminal of the connector; and
detecting whether the connector is corrupted, using a pull-up technique, when the external voltage is not supplied to the voltage terminal of the connector.
